(19) United States
(12) Patent Application Publication
(10) Pub. No.: US 2012/0185912 A1
(43) Pub. Date: Jul. 19, 2012

(54) SYSTEM AND METHOD FOR GRANTING AUTHORIZATION OF APPLICATION IN WIRELESS COMMUNICATION SYSTEM

(75) Inventors: Ji-Cheol Lee, Suwon-si (KR); Alper Yegin, Resitpasa Sariyer (TR); Sung-Ho Choi, Suwon-si (KR); Beom-Sik Bae, Suwon-si (KR); Jung-Shin Park, Seoul (KR); Song-Yean Cho, Seoul (KR)

(73) Assignee: SAMSUNG ELECTRONICS CO., LTD., Suwon-si (KR)

(21) Appl. No.: 13/352,149

(22) Filed: Jan. 17, 2012

(30) Foreign Application Priority Data
Jan. 17, 2011 (KR) 10-2011-0004458

(51) Int. Cl. H04W 12/06; G06F 17/30

(52) U.S. Cl. 726/1; 726/4

(57) ABSTRACT

A system and a method for grant authorization of an application in a wireless communication system. A method for being assigned authorization of an application in a mobile station includes when an application is installed, transmitting permission request information for at least one authorization required by the application, to a server; when receiving a response message from the server, identifying authorization assigned to the application in the response message; and controlling the application using the assigned authorization.

### CROSS-REFERENCE TO RELATED APPLICATION(S) AND CLAIM OF PRIORITY

The present application is related to and claims the benefit under 35 U.S.C. §119(a) to a Korean patent application filed in the Korean Intellectual Property Office on Jan. 17, 2011, and assigned Serial No. 10-2011-0004458, the entire disclosure of which is hereby incorporated by reference.

### TECHNICAL FIELD OF THE INVENTION

The present disclosure relates to a system and a method for granting authorization of an application in a wireless communication system.

### BACKGROUND OF THE INVENTION

As the supply of mobile communication terminals grows, mobile communication terminals of various designs, functions, and efficiencies are released to satisfy diverse demands of users. Besides, the supply of smart phones which graft a portable phone of communication capability and a Personal Digital Assistant (PDA) of computing capability rapidly rises.

The smart phone supports a portable computer function, an electronic note function, Internet search function, and the like. As the supply of the smart phone sharply increases, a great number of applications for the smart phone are under development.

When an application is installed to the smart phone, a permission request for the authorization required by the application is granted by a package installer.

As discussed above, the permission request of the application is set and granted by an application developer, and does not include a policy of a communication carrier which provides the communication service to the smart phone.

In this regard, what is needed is a method for reflecting policy characteristics of the communication carrier in the permission request of the application installed to the smart phone.

### SUMMARY OF THE INVENTION

To address the above-discussed deficiencies of the prior art, it is a primary aspect of the present disclosure to provide a system and a method for granting authorization of an application in a wireless communication system.

Another aspect of the present disclosure is to provide a system and a method for granting authorization of an application by reflecting application service policy characteristics of a communication carrier in a wireless communication system.

Yet another aspect of the present disclosure is to provide a system and a method for requesting permission of authorization required by an application in a mobile station of a wireless communication system.

Still another aspect of the present disclosure is to provide a system and a method for periodically requesting permission of authorization required by an application in a mobile station of a wireless communication system.

A further aspect of the present disclosure is to provide a system and a method for requesting permission of authorization required by an application according to change of an application service policy of a communication carrier in a wireless communication system.

A further aspect of the present disclosure is to provide a system and a method for requesting permission of authorization required by an application according to change of a communication carrier in a wireless communication system.

According to one aspect of the present disclosure, a method for being assigned authorization of an application in a mobile station of a wireless communication system includes when an application is installed, transmitting permission request information for at least one authorization required by the application, to a server; when receiving a response message from the server, identifying authorization assigned to the application in the response message; and controlling the application using the assigned authorization.

According to another aspect of the present disclosure, a method for assigning authorization of an application to a mobile station in a server of a wireless communication system includes when receiving permission request information for an application from the mobile station, determining whether to assign a required authorization of the application of the permission request information; and when assigning at least one of authorizations required by the application, transmitting the authorization assignment information to the mobile station.

According to yet another aspect of the present disclosure, an apparatus for being assigned an authorization of an application in a mobile station of a wireless communication system includes an application layer for installing an application; and an authorization setting module for, when an application is installed, transmitting permission request information for at least one authorization required by the application to a server, and when receiving a response message from the server, controlling the application using the authorization assigned to the application as identified in the response message.

According to still another aspect of the present disclosure, an apparatus for assigning authorization of an application to a mobile station in a server of a wireless communication system includes a communication interface; an authorization determiner for, when receiving permission request information for an application from the mobile station through the communication interface, determining whether to assign a required authorization of the application of the permission request information; and a controller for transmitting authorization information assigned by the authorization determiner to the application of the mobile station, to the mobile station through the communication interface.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain exemplary embodiments of the present disclosure will be more apparent from the following description taken in conjunction with the accompanying drawings, in which:

FIG. 1 illustrates a wireless communication system according to an exemplary embodiment of the present disclosure;

FIG. 2 illustrates a mobile station according to an exemplary embodiment of the present disclosure;

FIG. 3 illustrates a method for assigning authorization of an application in the wireless communication system according to an exemplary embodiment of the present disclosure;

FIG. 4 illustrates a method for assigning the authorization of the application in the wireless communication system according to another exemplary embodiment of the present disclosure;

FIG. 5 illustrates a method for periodically assigning the authorization of the application in the wireless communication system according to an exemplary embodiment of the present disclosure;

FIG. 6 illustrates a method for changing the authorization of the application in the wireless communication system according to an exemplary embodiment of the present disclosure;

FIG. 7 illustrates a method for changing the authorization of the application in the wireless communication system according to an exemplary embodiment of the present disclosure; and

FIG. 8 illustrates an Application Authorization Server (APP-AS) according to an exemplary embodiment of the present disclosure.

Throughout the drawings, like reference numerals will be understood to refer to like parts, components and structures.

### DETAILED DESCRIPTION OF THE INVENTION

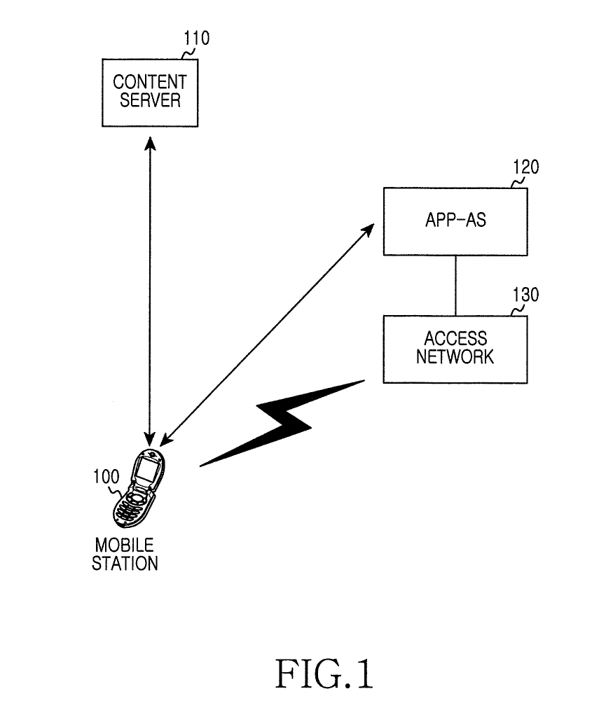

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. Embodiments of the present invention will be described herein below with reference to the accompanying drawings.

In the following description, well-known functions or constructions are not described in detail since they would obscure the invention in unnecessary detail. Terms described below, which are defined considering functions in the present invention, can be different depending on user and operator's intention or practice. Therefore, the terms should be defined based on the disclosure throughout this specification. Preferred embodiments of the present invention will be described herein below with reference to the accompanying drawings.

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present disclosure provide a technique for requesting permission of authorization required by an application in a mobile station of a wireless communication system.

Hereinafter, it is assumed that the mobile station is a portable terminal which supports the application.

Hereafter, the permission request for the application can be divided into an operator permission request, a mobile station permission request, and an apparatus permission request. The operator permission request indicates the permission request for the authorization of an application for providing a service using resources of the operator. For example, the operator permission request includes permission requests of usage rights such as Quality of Service (QoS) bearer, sponsored traffic, and message service. The mobile station permission request includes permission requests of the application for the usage right for a database (DB) of the mobile station and the usage right for a location service of the mobile station. The apparatus permission request includes permission requests of the application for the usage rights of modules of the mobile station.

FIG. 1 depicts a wireless communication system according to an exemplary embodiment of the present disclosure.

As shown in FIG. 1, the wireless communication system includes a mobile station 100, a content server 110, an Application Authorization Server (APP-AS) 120, and an access network 130.

The mobile station 100 provides a communication service through a communication carrier, and a service according to various contents provided from the content server 110. For example, when downloading an application, the mobile station 100 requests a required permission for the authorization of the corresponding application to the APP-AS 120 using an Application Enforcement Agent (APP-EA). For example, when an application service policy change search event occurs, the mobile station 100 requests a required permission for the authorization of the corresponding application to the APP-AS 120 using the APP-EA. Herein, the application service policy change search event periodically occurs. For example, when an application service policy of an operator is changed, the mobile station 100 requests a required permission for the authorization of the corresponding application to the APP-AS 120 using the APP-EA. For example, when the operator is changed, the mobile station 100 requests a required permission for the authorization of the corresponding application to the APP-AS 120 using the APP-EA. Herein, the operator represents a communication carrier which provides the communication service to the mobile station 100. At this time, the operator includes the APP-AS 120.

The APP-AS 120 assigns the authorization of the application to the mobile station 100 according to the permission request of the mobile station 100. For example, the APP-AS 120 determines whether to approve the permission request of the mobile station 100. In so doing, the APP-AS 100 may assign the unrequested authorization of the mobile station 100 to the application of the mobile station 100.

The access network 130 interconnects the mobile station 100 and a core network so that the mobile station 100 can access the core network over a wireless network. For example, the access network 130 includes a Policy and Charging Rule Function (PCRF), a gateway (GW), and a base station.

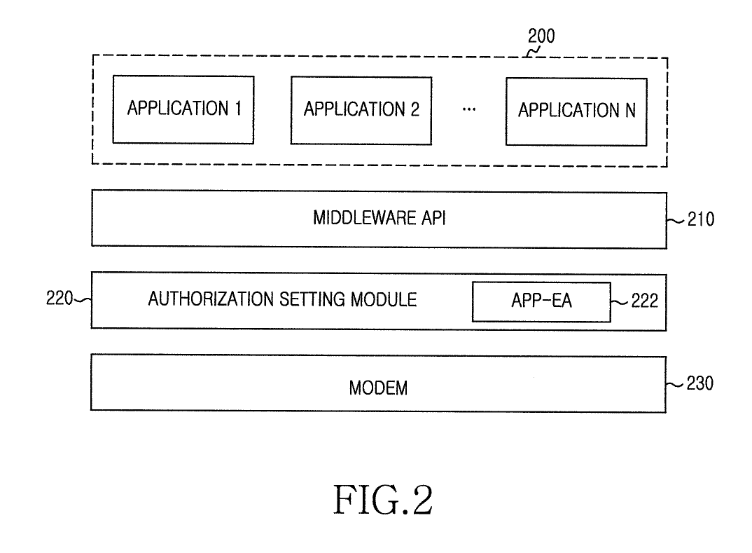

As stated above, when requesting the required permission of the authorization of the application, the mobile station 100 requests the required permission of the authorization of the application to the operator using the APP-EA of an authorization setting module of FIG. 2. Herein, the authorization setting module includes middleware of the mobile station 100.

FIG. 2 depicts the mobile station according to an exemplary embodiment of the present disclosure.

As shown in FIG. 2, the mobile station 100 includes an application layer 200, a middleware Application Programming Interface (API) 210, the authorization setting module 220, and a modem 230.

The application layer 200 has information of the application provided from the content server 110 and installed by the mobile station 100. For example, the application layer 200 identifies the permission request information of the application in a manifest file received from the content server 110.

The middleware API 210 is interposed between the application layer 200 and the authorization setting module 220, and controls communication between the application of the application layer 200 and the authorization setting module 220.

The authorization setting module 220 includes an APP-EA 222. When the application is installed to the application layer 200, the APP-EA 222 requests the required permission of the authorization of the installed application to the APP-AS 120 of FIG. 1. For example, the APP-EA 222 may periodically request the required permission of the authorization of the installed application to the APP-AS 120. For example, when the application service policy of the operator is changed, the APP-EA 222 may request the required permission of the authorization of the installed application to the APP-AS 120. For example, when the operator which provides the service to the mobile station 100 is changed, the APP-EA 222 may request the required permission of the authorization of the installed application to the APP-AS 120. Herein, the authorization setting module 220 includes the middleware of the mobile station 100.

According to the authorization assigned by the APP-AS 120, the APP-EA 222 may control the application. For example, when the APP-AS 120 restricts activity of the application, the APP-EA 222 controls to restrict the activity of the corresponding application. More specifically, when the corresponding application requests the activity through the middleware API 210, the APP-EA 222 limits the activity of the application.

The modem 230, which is hardware of the mobile station 100, processes signals transmitted and received over the wireless network.

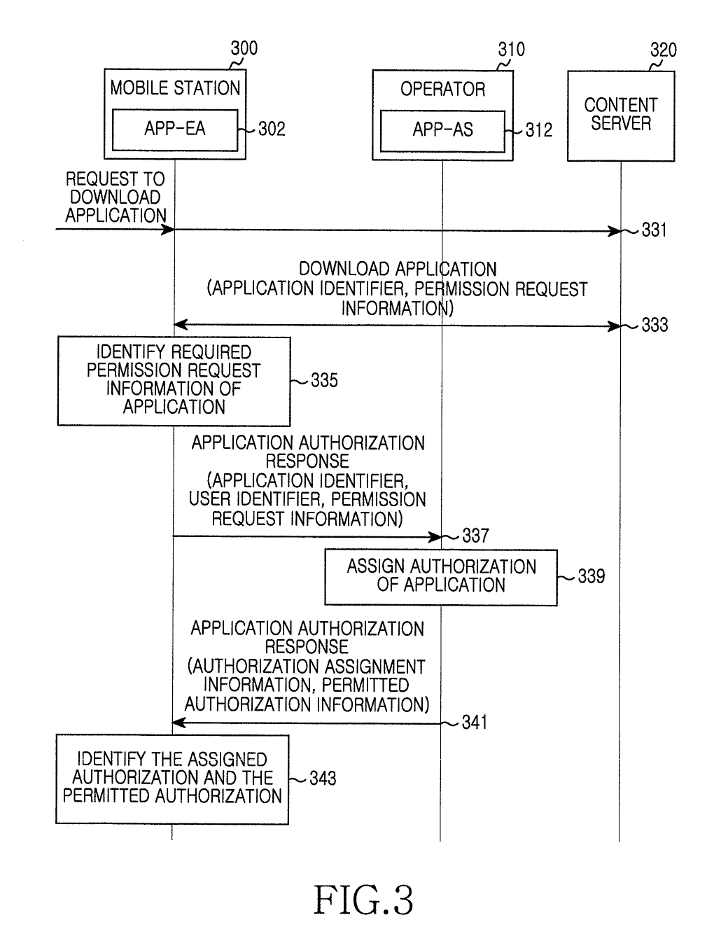

As above, when the application is installed, the mobile station 100 requests the required permission of the authorization of the application to the operator. In so doing, the APP-AS 120 of the operator can assign at least one authorization to the application of the mobile station 100 according to the permission request of the mobile station 100 as shown in FIG. 3.

FIG. 3 illustrates a method for assigning the authorization of the application in the wireless communication system according to an exemplary embodiment of the present disclosure.

When a user of a mobile station 300 requests to download an application, the mobile station 300 requests the download of the application to a content server 320 in step 331.

The content server 320 transmits the application requested by the mobile station 300, to the mobile station 300 in step 333. At this time, the application includes an application identifier, required permission request information of the authorization of the application, and the manifest file including authorization information. Herein, the application identifier includes at least one of an identifier of the application and an identifier of the operating system.

The mobile station 300 installs the application received from the content server 320.

The mobile station 300 identifies the permission request information of the required authorization such that the installed application provides the service in step 335. For example, the mobile station 300 identifies the permission request information of the required authorization of the application by verifying a signature of the application.

Next, the mobile station 300 requests the required permission of the authorization of the application to an APP-AS 312 of an operator 310 via an APP-EA 302 in step 337. For example, the mobile station 300 sends an application authorization request message including the application identifier, a user identifier, and the required permission request information of the authorization of the application, to the APP-AS 312 of the operator 310. Herein, the permission request information may include permission request information of a particular API.

According to the application service policy, the APP-AS 312 of the operator 310 determines the authorization to be assigned to the application of the mobile station 300 in step 339. That is, the APP-AS 312 determines whether to permit the authorizations of the permission request information of the mobile station 300.

When approving at least one of the authorizations requested by the mobile station 300, the APP-AS 312 of the operator 310 sends an application authorization response message including the at least one authorization information permitted, to the mobile station 300 in step 341. Herein, the application authorization response message includes information about whether the authorization of the application is assigned and the permission request information approved by the APP-AS 312.

The APP-EA 302 of the mobile station 300 identifies the authorization assigned by the APP-AS 312 and the permission request information approved by the APP-AS 312, in the application authorization response message in step 343. The mobile station 300 can display the assigned authorization information in a screen so that the user can check it.

In this embodiment, the mobile station 300 installs the application and then requests the required permission of the authorization of the application. When the authorization of the application is predetermined, the mobile station 300 may not request the required permission of the authorization of the application.

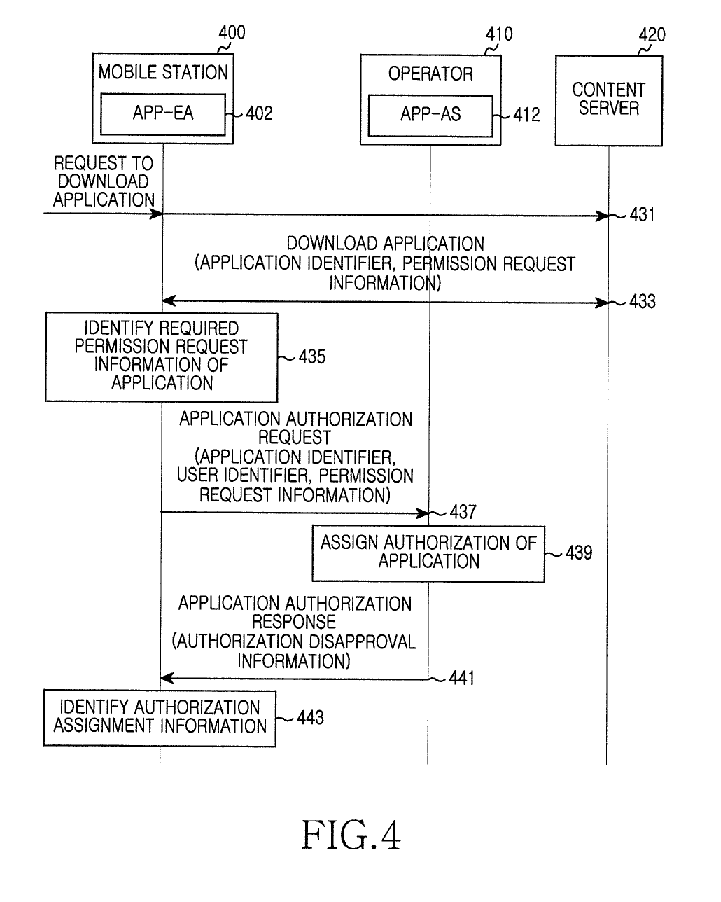

In this embodiment, the APP-AS 120 grants at least one of the authorizations requested by the mobile station 100. When the APP-AS 120 permits neither of the authorizations requested by the mobile station 100, the APP-AS 120 and the mobile station 100 operate as shown in FIG. 4.

FIG. 4 illustrates a method for assigning the authorization of the application in the wireless communication system according to another exemplary embodiment of the present disclosure.

When a user of a mobile station 400 requests to download an application, the mobile station 400 requests the download of the corresponding application to a content server 420 in step 431.

The content server 420 transmits the application requested by the mobile station 400, to the mobile station 400 in step 433. At this time, the application includes the application identifier, the required permission request information of the authorization of the application, and the manifest file including the authorization information. Herein, the application identifier includes at least one of the identifier of the application and the identifier of the operating system.

The mobile station 400 installs the application received from the content server 420.

The mobile station 400 identifies the required permission request information of the authorization such that the installed application provides the service in step 435. For example, the mobile station 400 identifies the required permission request information of the authorization of the application by verifying the signature of the application.

Next, the mobile station 400 requests the required permission of the authorization of the application to an APP-AS 412 of an operator 410 via an APP-EA 402 in step 437. For example, the mobile station 400 sends an application authorization request message including the application identifier, the user identifier, and the required permission request information of the authorization of the application, to the APP-AS 412 of the operator 410.

According to the application service policy, the APP-AS 412 of the operator 410 determines the authorization to be assigned to the application of the mobile station 400 in step 439. That is, the APP-AS 412 determines whether to grant each authorization of the permission request information of the mobile station 400.

When not permitting the authorization requested by the mobile station 400, the APP-AS 412 of the operator 410 sends an application authorization response message including the authorization disapproval information, to the mobile station 400 in step 441.

The APP-EA 402 of the mobile station 400 identifies no authorization assigned by the APP-AS 412 in the application authorization response message in step 443. The mobile station 400, which is not authorized by the APP-AS 412 for the service, can display information indicating that the corresponding application is infeasible, in the screen.

In this embodiment, as installing the application, the mobile station 100 requests the required permission of the authorization of the installed application, to the APP-AS 120.

Alternatively, after installing the application, the mobile station 100 periodically requests the required permission of the authorization of the application in order to check whether the policy of the application is changed.

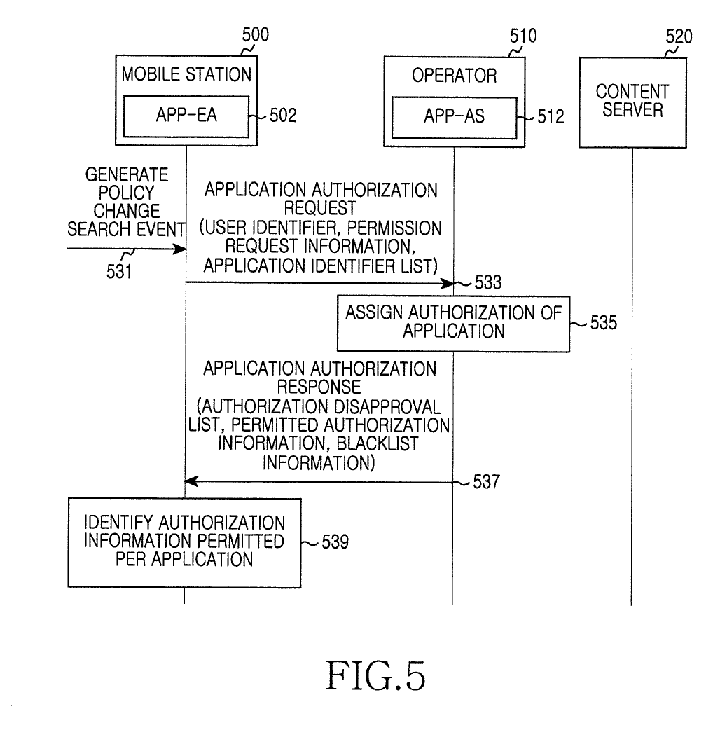

FIG. 5 illustrates a method for periodically assigning the authorization of the application in the wireless communication system according to an exemplary embodiment of the present disclosure.

In FIG. 5, a mobile station 500 provides the service by installing an application downloaded from a content server 520.

When the application service policy change search event occurs in step 531, the mobile station 500 requests the required permission of the authorization of the application to an APP-AS 512 of an operator 510 via an APP-EA 502 in step 533. For example, the mobile station 500 sends an application authorization request message including an application identifier list, the user identifier, and the required permission request information of the authorization of the applications, to the APP-AS 512 of the operator 510. Herein, the application identifier list includes identifies of one or more applications installed to the mobile station 500.

According to the application service policy, the APP-AS 512 of the operator 510 determines the authorization to be assigned to the applications of the application identifier list in step 535. That is, the APP-AS 512 determines whether to assign the authorization to each application and whether to approve the permission request information of the application authorized.

Next, the APP-AS 512 of the operator 510 sends to the mobile station 500, an application authorization response message including the authorization information assigned to the applications in step 537. Herein, the application authorization response message includes at least one of an unauthorized application list, permitted authorization information of the APP-AS 512 for the authorized applications, and blacklist information. Herein, the blacklist information indicates a list of applications forbidden to use and install in the mobile station 500.

The APP-EA 502 of the mobile station 500 identifies the authorization information assigned to the applications in the application authorization response message in step 539. Also, the APP-EA 502 of the mobile station 500 deletes the applications of the blacklist information or blocks the activity of the corresponding applications as identified in the application authorization response message.

In this embodiment, when the application service policy change search event occurs, the mobile station 500 requests the authorization permission of the application.

Alternatively, when the application service policy change search event occurs, the mobile station 500 determines whether the application service policy of the operator 510 is changed. In detail, when the application service policy change search event takes place, the mobile station 500 checks whether the application service policy of the operator 510 is changed by sending an application service policy change check message to the operator 510.

In this example, only when identifying the application service policy change of the operator 510, the mobile station 500 requests the authorization permission of the application to the operator 510.

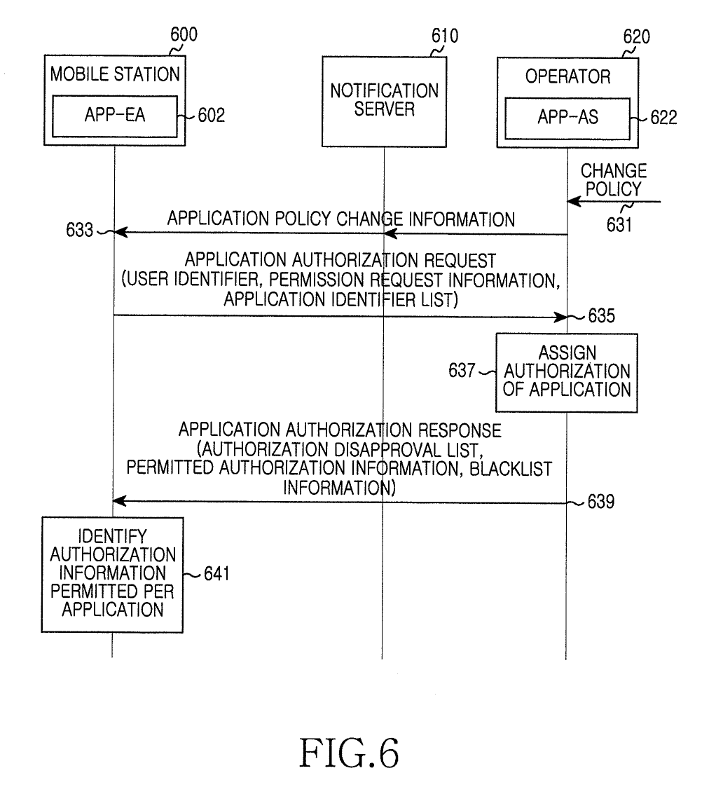

Alternatively, the mobile station 500 may request the authorization permission of the application to the operator 510 according to application service policy change information provided from the operator 510 as shown in FIG. 6.

FIG. 6 illustrates a method for changing the authorization of the application in the wireless communication system according to an exemplary embodiment of the present disclosure.

In FIG. 6, a mobile station 600 provides the service by installing an application downloaded from a content server. In so doing, the mobile station 600 drives the application according to the authorization assigned from an operator 620 as shown in FIG. 3 or FIG. 4.

When the application service policy of the operator 620 is changed in step 631, the operator 620 transmits the application service policy change information to the mobile station 600 via a notification server 610 in step 633.

According to the application service policy change information, the mobile station 600 requests the required permission for the authorization of the application to an APP-AS 622 of the operator 620 through an APP-EA 602 in step 635. For example, the mobile station 600 sends an application authorization request message including the application identifier list, the user identifier, and the required permission request information for the authorization of the applications, to the APP-AS 622. Herein, the application identifier list includes the identifier of at least one application installed to the mobile station 600.

Based on the application service policy, the APP-AS 622 of the operator 620 determines the authorization to be assigned to the applications of the application identifier list in step 637. That is, the APP-AS 622 determines whether to assign the authorization to each application and whether to approve the permission request information of the application authorized.

In step 639, the APP-AS 622 sends to the mobile station 600, an application authorization response message including the authorization information assigned to the applications. Herein, the application authorization response message includes at least one of an unauthorized application list, permitted authorization information of the APP-AS 622 for the authorized applications, and blacklist information. The blacklist information indicates the list of applications forbidden to use and install in the mobile station 600.

The APP-EA 602 of the mobile station 600 identifies the authorization information assigned to the applications in the application authorization response message in step 641. Also, the APP-EA 602 of the mobile station 600 deletes the applications of the blacklist information or blocks the activity of the corresponding applications as identified in the application authorization response message.

In this embodiment, when the application service policy of the operator 620 is changed, the mobile station 600 requests the authorization permission of the application to the APP-AS 622.

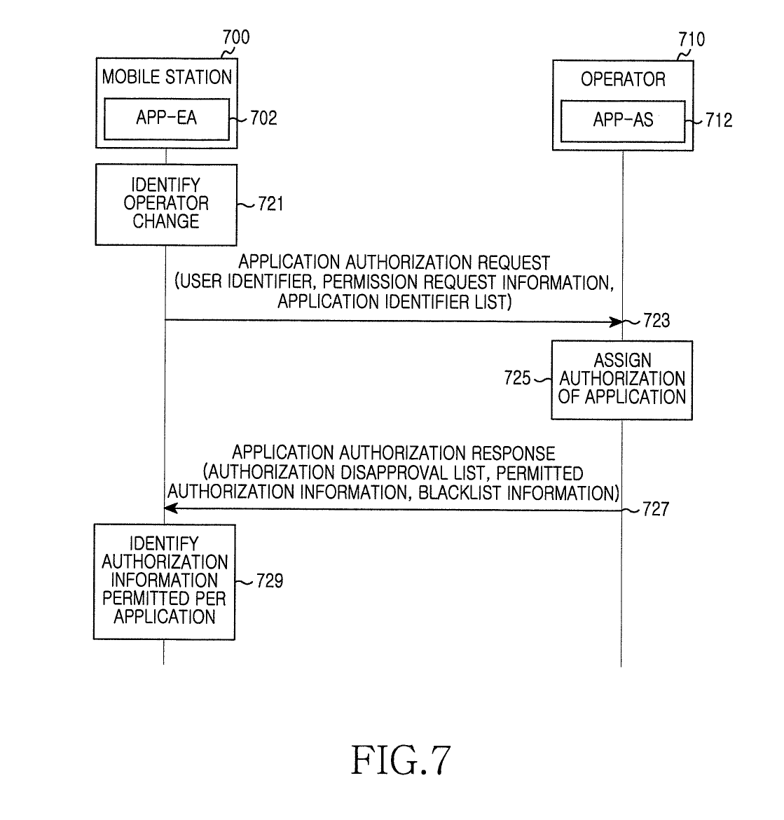

Alternatively, when the operator 620 is changed, the mobile station 600 can request the authorization permission of the application to the APP-AS of the changed operator as shown in FIG. 7.

FIG. 7 illustrates a method for changing the authorization of the application in the wireless communication system according to an exemplary embodiment of the present disclosure.

A mobile station 700 provides the service by installing an application downloaded from a content server. In so doing, the mobile station 700 drives the application according to the authorization assigned from an operator of the communication carrier as shown in FIG. 3 or FIG. 4.

When the operator which services the mobile station 700 is changed, the mobile station 700 obtains an address of the changed operator 710 in step 721. For example, the mobile station 700 obtains the address of an APP-AS 712 of the changed operator 710 using Domain Name System (DNS). For example, the mobile station 700 can obtain the address of the APP-AS 712 of the changed operator 710 according to an update scheme using Open Mobile Alliance-Device Management (OMA-DM).

Next, using the obtained address of the APP-AS 712, the mobile station 700 requests the required permission for the authorization of the application to the APP-AS 712 of the operator 710 via an APP-EA 702 in step 723. For example, the mobile station 700 sends to the APP-AS 712, an application authorization request message including the application identifier list, the user identifier, and the required permission request information for the authorization of the applications. Herein, the application identifier list includes the identifier of at least one application installed to the mobile station 700.

Based on the application service policy, the APP-AS 712 of the operator 710 determines the authorization to be assigned to the applications of the application identifier list in step 725. That is, the APP-AS 712 determines whether to assign the authorization to each application and whether to approve the permission request information of the application authorized.

In step 727, the APP-AS 712 sends to the mobile station 700, an application authorization response message including the authorization information assigned to the applications. Herein, the application authorization response message includes at least one of an unauthorized application list, permission information approved by the APP-AS 712 for the authorized applications, and blacklist information. The blacklist information indicates the list of applications forbidden to use and install in the mobile station 700.

The APP-EA 702 of the mobile station 700 identifies the authorization information assigned to the applications in the application authorization response message in step 729. Also, the APP-EA 702 of the mobile station 700 deletes the applications of the blacklist information or blocks the activity of the corresponding applications as identified in the application authorization response message.

Now, a structure of the APP-AS for assigning the authorization of the application according to the permission request of the mobile station is explained.

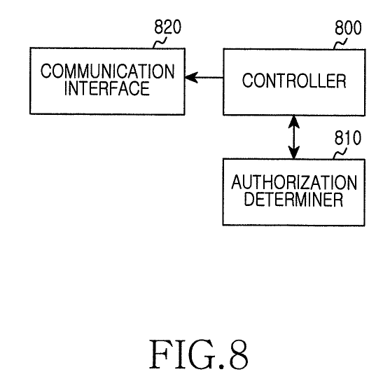

FIG. 8 is a block diagram of the APP-AS according to an exemplary embodiment of the present disclosure.

The APP-AS includes a controller 800, an authorization determiner 810, and a communication interface 820 as shown in FIG. 8.

The controller 800 controls the operations of the APP-AS. For example, when the mobile station requests the authorization permission of the application, the controller 800 controls the authorization determiner 810 to assign the authorization to the application of the mobile station. When assigning the application authorization of the mobile station to the authorization determiner 810, the controller 800 controls to send the application authorization response message including the authorization assignment information to the mobile station.

When the application service policy is modified, the controller 800 controls to transmit the application service policy change information to the mobile station.

Under the control of the controller 800, the authorization determiner 810 assigns the authorization for the applications. For example, when the mobile station requests the authorization permission for the plurality of the applications, the authorization determiner 810 selects the application to authorize among the applications. Next, the authorization determiner 810 determines the authorization to be assigned to the applications by considering the authorization permission request information of the applications.

The communication interface 820 sends and receives signals to and from the APP-EA of the mobile station.

As set forth above, since the mobile station of the wireless communication system is assigned the required authorization of the application from the communication carrier, the mobile station can provide the service through the application according to the application service policy of the communication carrier.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for being assigned authorization of an application in a mobile station of a wireless communication system, the method comprising:
when an application is installed, transmitting permission request information for at least one authorization required by the application to a server;
when receiving a response message from the server, identifying authorization assigned to the application in the response message; and
controlling the application using the assigned authorization.

2. The method of claim 1, wherein the at least one authorization required by the application is identified in a manifest file of the application provided from a content server.

3. The method of claim 1, wherein transmitting the permission request information comprises:
transmitting, to the server, an application authorization request message comprising an application identifier, a user identifier, and permission request information for at least one authorization required by the application.

4. The method of claim 1, wherein the permission request information comprises application programming interface (API) permission request information.

5. The method of claim 1 further comprising:
determining whether a policy change check cycle arrives; and
when the policy change check cycle arrives, transmitting the permission request information for at least one authorization required by the application to the server.

6. The method of claim 1 further comprising:
when receiving application service policy change information from the server, transmitting the permission request information for at least one authorization required by the application to the server.

7. The method of claim 1 further comprising:
when an operator which provides a service to the mobile station is changed, checking an address of a server of the changed operator; and
transmitting the permission request information for at least one authorization required by the application to the server of the changed operator using the address of the server.

8. The method of claim 7, wherein checking the address comprises:
obtaining the address of the server of the changed operator using any one of Domain Name System (DNS) and Open Mobile Alliance-Device Management (OMA-DM).

9. A method for assigning authorization of an application to a mobile station in a server of a wireless communication system, the method comprising:
when receiving permission request information for an application from the mobile station, determining whether to assign a required authorization of the application of the permission request information; and
when assigning at least one of authorizations required by the application, transmitting authorization assignment information to the mobile station.

10. The method of claim 9, wherein the permission request information comprises application programming interface (API) permission request information.

11. The method of claim 9, wherein determining whether to assign comprises:
when receiving permission request information for a plurality of applications from the mobile station, determining at least one of the applications to authorize; and
determining whether to assign a required authorization of the at least one application to authorize.

12. The method of claim 9 further comprising:
determining whether an application service policy is changed; and
when the application service policy is changed, transmitting application service policy change information to the mobile station,
wherein, after transmitting the application service policy change information, whether permission request information of the application is received from the mobile station is determined.

13. An apparatus for being assigned an authorization of an application in a mobile station of a wireless communication system, the apparatus comprising:
an application layer configured to install an application; and
an authorization setting module configured to, when an application is installed, transmit permission request information for at least one authorization required by the application to a server; and when receiving a response message from the server, control the application using the authorization assigned to the application as identified in the response message.

14. The apparatus of claim 13, wherein the application layer is further configured to identify the permission request information of the at least one authorization required by the application in a manifest file of the application provided from a content server.

15. The apparatus of claim 13, wherein the authorization setting module is further configured to transmit an application authorization request message comprising an application identifier, a user identifier, and permission request information for at least one authorization required by the application, to the server through an Application Enforcement Agent (APP-EA).

16. The apparatus of claim 13, wherein the permission request information comprises application programming interface (API) permission request information.

17. The apparatus of claim 13, wherein when a policy change check cycle arrives, the authorization setting module is further configured to transmit the permission request information for at least one authorization required by the application to the server.

18. The apparatus of claim 13, wherein when receiving application service policy change information from the server, the authorization setting module is further configured to transmit the permission request information for at least one authorization required by the application to the server.

19. The apparatus of claim 13, wherein when an operator which provides a service to the mobile station is changed, the authorization setting module is further configured to transmit the permission request information for at least one authorization required by the application to a server of the changed operator.

20. The apparatus of claim 19, wherein the authorization setting module is further configured to obtain an address of the server of the changed operator using any one of Domain Name System (DNS) and Open Mobile Alliance-Device Management (OMA-DM).

21. An apparatus for assigning authorization of an application to a mobile station in a server of a wireless communication system, the apparatus comprising:
a communication interface;
an authorization determiner configured to, when receiving permission request information for an application from the mobile station through the communication interface, determine whether to assign a required authorization of the application of the permission request information; and
a controller configured to transmit authorization information assigned by the authorization determiner to the application of the mobile station, to the mobile station through the communication interface.

22. The apparatus of claim 21, wherein the permission request information comprises application programming interface (API) permission request information.

23. The apparatus of claim 21, wherein when receiving permission request information for a plurality of applications from the mobile station, the authorization determiner is further configured to determine at least one application to authorize among the plurality of the applications, and determine whether to assign a required authorization of the at least one application to authorize.

24. The apparatus of claim 21, wherein when the application service policy is changed, the controller is further configured to transmit application service policy change information to the mobile station through the communication interface.
